(19) United States
(12) Patent Application Publication
(10) Pub. No.: US 2025/0214580 A1
(43) Pub. Date: Jul. 3, 2025

(54) MACHINE TRAVEL CONTROL BASED ON VISION SYSTEM HEALTH

(71) Applicant: Caterpillar Inc., Peoria, IL (US)

(72) Inventors: Karl KIRSCH, Chillicothe, IL (US); Matthew D. JOHNSON, Dunlap, IL (US); Matthew E. KONTZ, Peoria, IL (US)

(73) Assignee: Caterpillar Inc., Peoria, IL (US)

(21) Appl. No.: 18/398,693

(22) Filed: Dec. 28, 2023

(51) Int. Cl. B60W 30/14

(52) U.S. Cl. CPC B60W 30/143; B60W 2300/125; B60W 2300/17; B60W 2554/802; B60W 2556/50; B60W 2720/10

(57) ABSTRACT

A system for speed control of a machine includes a mobile machine configured for traversing a worksite, the mobile machine including ground-engaging devices for propelling the mobile machine at a travel speed, and a vision system. The vision system includes a perception sensor and a controller. The controller is configured to receive signals from the perception sensor, determine when the perception sensor successfully identifies a target, determine when the perception sensor is unsuccessful in identifying the target, and set a travel speed limit of the machine based on whether the target was successfully identified.

### TECHNICAL FIELD

This disclosure relates generally to monitoring one or more aspects of a vision system for a machine, and more particularly, to systems and methods for controlling machine travel based on the vision system.

### BACKGROUND

Haul trucks are used at mining sites and other locations to transport large quantities of material. Increasingly, machines that operate at work sites, including mines, are capable of operating in a fully autonomous or partially autonomous manner. In some examples, machines are operated remotely. Vision systems, including systems that employ LIDAR (light detection and ranging), can be used to assist with autonomous or remote operation. These sensors allow a system controlling the machine to detect a desired path and identify objects, such as debris, vehicles, personnel, or other obstructions that should be avoided.

Productivity of autonomous or remotely-operated machines is generally increased by operating the machines at higher speeds. While operation at higher speeds is desirable, high-speed operation relies on the accuracy of the vision system. While these vision systems operate effectively under varying conditions, the health of a vision systems can degrade over time. This degradation occurs as the machine is operated following calibration of the vision system. For example, buildup of debris or soil on sensors of the vision system can reduce their effectiveness, sensors can fail over time, become disconnected, lose alignment, or for other reasons experience difficulty in accurately identifying a path for travel, obstacles, and other objects.

An exemplary system for camera calibration is described in U.S. Pat. No. 11,657,536 B2 (“the '536 patent”) to Wendel et al. The system described in the '536 patent uses fiducial markers to calibrate a camera for operating an autonomous vehicle. The calibration is performed to determine features of the camera such as distortion, camera matrices, lens position or orientation, camera sensor position or orientation, and others. While the system described in the '536 patent may be helpful for performing an initial calibration, it is unable to determine health of one or more vision sensors during operation of the machine.

The techniques of this disclosure may solve one or more of the problems set forth above and/or other problems in the art. The scope of the current disclosure, however, is defined by the attached claims, and not by the ability to solve any specific problem.

### SUMMARY

In one aspect, a system for speed control of a machine may include a mobile machine configured for traversing a worksite, the mobile machine including ground-engaging devices for propelling the mobile machine at a travel speed, and a vision system. The vision system may include a perception sensor and a controller. The controller may be configured to receive signals from the perception sensor, determine when the perception sensor successfully identifies a target, determine when the perception sensor is unsuccessful in identifying the target, and set a travel speed limit of the machine based on whether the target was successfully identified.

In another aspect, a system for setting travel permissions of a machine may include a perception sensor configured to generate a signal that indicates a presence of an object and a distance, and a controller. The controller may be configured to receive the signal, determine when the signal indicates the presence of a target, and confirm whether a target was successfully identified based on the signal.

In yet another aspect, a method for controlling travel permissions for a machine may include receiving signals from a perception sensor and identifying one or more vision system targets while the machine is in motion. The method may also include confirming whether each vision system target is successfully identified and setting a travel permission of the machine based on whether the target was successfully identified.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosure.

FIG. 1 is a partially-schematic view of an exemplary machine and machine speed control system, according to aspects of the disclosure.

FIG. 2 is a block diagram of a controller of the machine speed control system of FIG. 1.

FIG. 3 is a diagram representing a layout of a location, including elements that may be presented on a display, at which the machine speed control system may operate.

FIG. 4 is a flowchart of an exemplary method for controlling travel permissions for a machine, according to aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a method or apparatus that comprises a list of elements does not include only those elements, but may include other elements not expressly listed or inherent to such a method or apparatus. In this disclosure, relative terms, such as, for example, “about,” “substantially,” “generally,” and “approximately” are used to indicate a possible variation of +10% in the stated value or characteristic. As used herein, the phrase “based on” encompasses both “based entirely on” and “based at least on.”

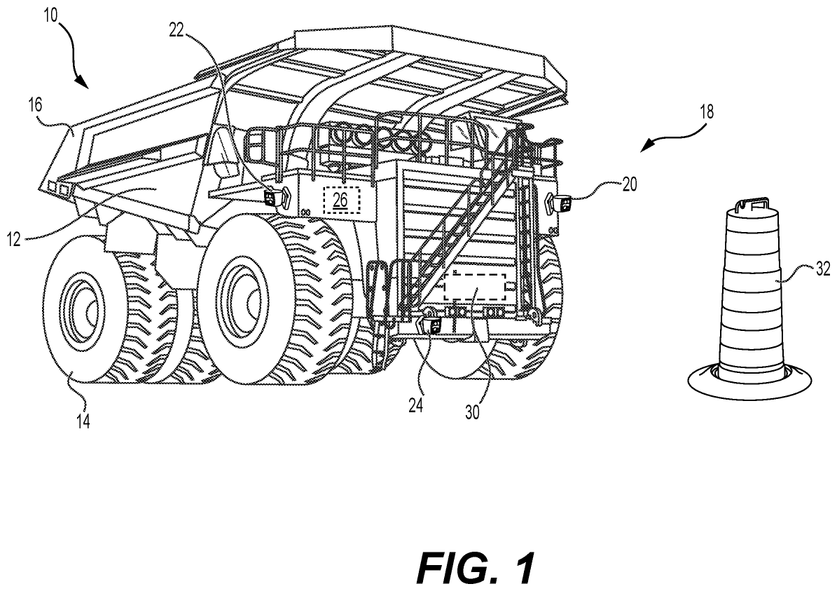

FIG. 1 is a partially schematic view showing a machine speed control system 10. Machine speed control system 10 may include a machine 12, a vision system 18, and a controller 30 that may be a component of vision system 18. Machine 12 may be a mobile machine that is configured to operate (e.g., navigate) based on objects detected with vision system 18. Machine 12 may be a haul truck as shown, a liquid storage truck (e.g., a water storage truck), an earthmoving machine (e.g., a motor grader, excavator, or dozer), a paving machine (e.g., a cold planer), or another type of mobile machine.

Machine 12 may include one or more ground-engaging devices 14, including tracks or wheels, that enable propulsion of machine 12 at various speeds. Machine 12 may include one or more devices for performing work, such as a haul bed 16 for containing material while machine 12 travels. Machine 12 may be configured for fully-autonomous operation in which no input is necessary during operation of machine 12, semi-autonomous operation in which some or occasional input is provided to machine 12 during operation, and/or remote operation in which some or all of the functions of machine 12 are controlled via a remote system.

Vision system 18 may include one or more sensors, such as a first perception sensor 20, a second perception sensor 22, and a third perception sensor 24, that facilitate autonomous or remote operation of machine 12. The sensors of vision system 18 may include more than one type of sensor, as well as multiple sensors of the same type. In the illustrated configuration, each of the three perception sensors 20, 22, and 24 are LIDAR (light detection and ranging) sensors that are configured to generate signals that indicate the presence of objects. Instead of or in addition to LIDAR sensors, vision system 18 may include other types of laser sensors or ranging devices, radar sensors, sonar sensors, vision sensors such as infrared cameras or cameras that capture visible light, etc. When signals from one or more perception sensors are analyzed with a controller (e.g., via one or more vision algorithms such as an obstacle detection algorithm) these signals provide vision system 18 with “vision” in the form of awareness of surrounding objects.

Multiple sensors 20, 22, and 24 may operate in conjunction with each other, such that signals from two or more sensors are used to identify a target 32. However, in some aspects, a single sensor 20, 22, or 24 is configured to identify a target independently and without the use of information from another sensor. Sensors 20, 22, 24 may be configured to identify the distance and shape of various types of features, including roadways, terrain, vehicles, debris (e.g., rocks), signposts, barrels (a barrel being one example of target 32, as shown in FIG. 1), and others. In the example of LIDAR, sensors 20, 22, 24 each generate a map of points, the points representing the distance light travels from the sensor before being reflected and returning to the sensor. The map of points may be processed to identify these features.

Vision system 18 may include one or more sensors that assist in determining the health of vision system 18. For example, vision system 18 may include a location sensor 26 that outputs a signal that represents a location (e.g., a geographic location) of machine 12. This location may be used by controller 30 to correlate a current or previous location of machine 12 with a location (e.g., a stored location) of one or more targets 32. Location sensor 26 may include a global navigation satellite system sensors (e.g., a Global Positioning System sensor), a separate ranging device (e.g., a radar device) or a ground-based location system.

Controller 30 may be programmed to control one or more aspects of system 10, including control over one or more travel permissions of machine 12 based on the health of vision system 18. For example, controller 30 may be configured to monitor and control vehicle speed (e.g., by setting a travel speed limit for machine 12), a minimum distance of machine 12 from an object, a destination of machine 12, prohibited areas to which machine 12 is not permitted to travel, operation of an implement of machine 12, or other travel permissions. Controller 30 may generate signals for propelling machine 12 at a desired speed, the speed being equal to or lower than the current travel speed limit. Controller 30 may be configured for electronic control of steering mechanism, an internal combustion engine, electric motor, battery system, fuel cell, or other power-generating device, as well as a power-transmitting device such as a transmission.

Controller 30 may encompass a single control unit that monitors the health of vision system 18, and controls one or more aspects of machine 12 such as components for propulsion or steering, a hydraulic system for operating an implement, or other aspects of machine 12. In some configurations, controller 30 is distributed as a plurality of individual controllers. As used herein, a “controller” encompasses both single controllers or control modules, or a plurality of controllers or control modules. Controller 30 may be enabled, via programming, to receive signals from sensors of 20, 22, 24, 26 as well as other sensors of vision system 18 and machine 12. Controller 30 may be configured, via programming, to receive signals from sensors 20, 22, 24, and signals correlated with a location of machine 12 (e.g., signals from location sensor 26) and determine the health of vision system 18 based on the signals from sensors 20, 22, 24, 26.

Controller 30 may embody a single microprocessor or multiple microprocessors that receive inputs and generate outputs. Controller 30 may include a memory, a secondary storage device, a processor such as a central processing unit, or any other means for accomplishing a task consistent with the present disclosure. The memory or secondary storage device associated with controller 30 may store data and software to allow controller 30 to perform its functions, including the functions described with respect to method 400. Numerous commercially available microprocessors can be configured to perform the functions of controller 30. Various other known circuits may be associated with controller 30, including signal filtering and analysis circuitry, command generation circuitry, communication circuitry, and other appropriate circuitry.

Target 32 may have a shape that is known to controller 30. For example, the shape of target 32 may be stored within a memory of controller 30. This shape may include, for example, a height of target 32. In particular, target 32 may be identified based on an object that has height that is equal to or greater than a predetermined height. If desired, other aspects of target 32 may be used to identify the target, such as a width, outline or shape, etc. In the illustrated example, target 32 is an object that may be associated with a task at a worksite other than vision system evaluation, a traffic barrel. In other aspects, an uncommon or unique target 32 may be used, such as a sign with a specific shape or predefined image. In the example of an object such as a barrel, the object may have a height that exceeds a predetermined height.

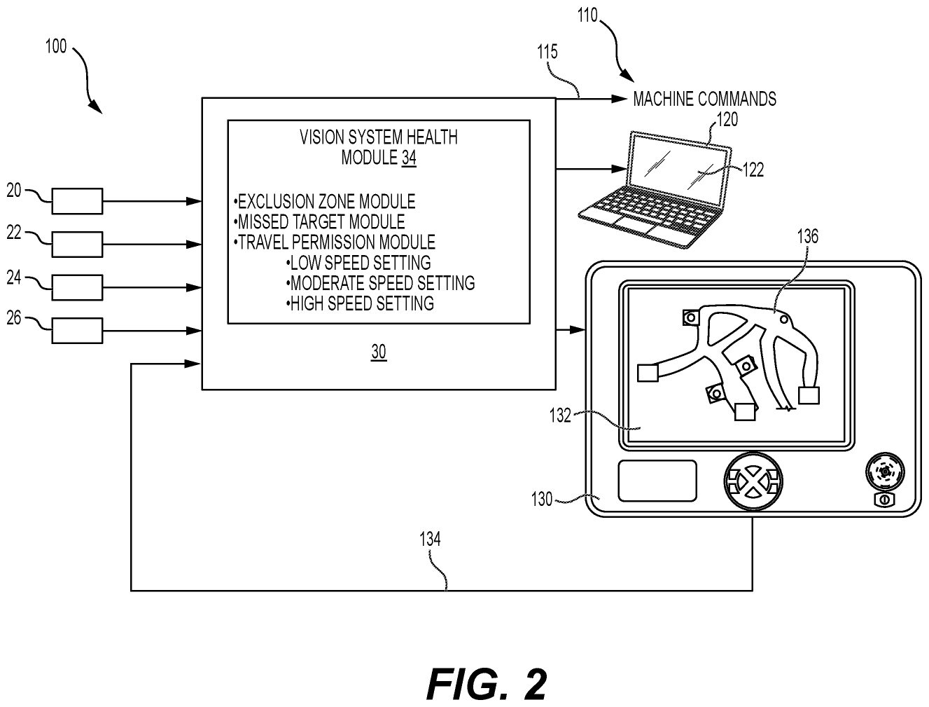

FIG. 2 is a block diagram illustrating an exemplary configuration of controller 30 and other components of machine speed control system 10. As shown in FIG. 2, controller 30 may include a vision system health module 34 configured to monitor health of system 18 after calibration of system 18. Controller 30 may also receive inputs 100 and generate one or more outputs 110. Inputs 100 may indicate a health of vision system 18 and are received while machine 12 is operating (e.g., is in motion). Outputs 110 may include notifications that are generated based on the health of vision system 18, as well as machine commands 115 for controlling one or more aspects of machine 12 based on the health of vision system 18.

In the illustrated example, inputs 100 include the above-described signals from sensors 20, 22, 24. These signals may identify a feature, such as terrain, paths or roadways, obstacles, and targets 32. Signals from sensor 26 may include a geographic location of machine 12, which may indicate a distance of machine 12 from target 32. The location of machine 12 may be correlated with a worksite map to determine the distance machine 12 is from a target 32 at a particular time.

Components of vision system health module 34 may include an exclusion zone module, a missed target module, and a travel permission module. The exclusion zone module may enable vision system health module 34 to identify the boundaries and locations of one or more exclusion zones. An exclusion zone may be an area of a worksite in which a target 32 or other object may be present, but in which it is desirable for machine 12 to continue traveling. For example, the phrase “exclusion zone” may refer to an area in which controller 30 may permit machine 12 to continue travelling despite the identification of an object (e.g., a target 32) within the exclusion zone. Outside of an exclusion zone, controller 30 may slow or stop machine 12 when these objects are identified. Thus, machine 12 continues traveling even when target 32 is identified within the exclusion zone. The exclusion zone module of vision system health module 34 may also facilitate creation, modification, or removal of an exclusion zone. For example, the exclusion zone module receives exclusion zone feedback 134, this feedback 134 being an input that modifies the size or location of one or more exclusion zones, as well as the presence of one or more targets 32 within an exclusion zone.

The missed target module may enable vision system health module 34 to determine when vision system 18 failed to identify a target 32. This may be accomplished by storing known locations of one or more targets in a memory associated with vision system health module 34. The current and past location of machine 12 may be evaluated by the missed target module, based on signals from sensors 28 and used to determine when machine 12 was within viewing distance of a target 32.

The missed target module may generate outputs when sensors 20, 22, 24 of machine 12 were within viewing distance of a target 32, but the target was not identified or was poorly identified. A target 32 is poorly identified when the missed target module determines that: only a portion of a target 32 was identified (e.g., captured by one or more of sensors 20, 22, 24), target 32 was initially captured at a distance that is less than a desired distance, target 32 was identified by one or more of sensors 20, 22, 24 while another one of sensors 20, 22, 24 failed to identify target 32, or machine 12 passed a target 32 without any sensor 20, 22, 24 identifying target 32.

The travel permission module may enable vision system health module 34 to set a speed limit, a target speed, or both, based on the health of vision system 18. The travel permission module stores a plurality of different speeds at which machine 12 travels due to propulsion with one or more ground-engaging devices 14.

The low speed setting (e.g., a first speed setting) may be a speed at which machine 12 travels when health of vision system 18 is relatively low. This speed may be set when vision system 18 missed one or more targets 32 or identified one or more targets 32 inside of a desired distance, as determined by the missed target module. In some aspects, the low speed setting may be an initial speed setting, the initial speed setting being a speed to which machine 12 is limited at startup and prior to encountering an exclusion zone containing a target 32. The moderate speed setting (e.g., a second speed setting) may be a speed that is higher than the low speed setting but lower than the high speed setting (e.g., a third speed setting).

Other permissions that may be set by the travel permission module include a minimum distance of machine 12 from a detected object, including a minimum distance of machine 12 from another machine. Lower permissions may be associated with greater minimum distances that are enforced by controller 30. Increased permissions may be associated with access to one or more areas to which travel is prohibited when machine 12 operates with lower permissions. Lower permissions may also be associated with limits to operation of an implement of machine 12 (e.g., limiting use of an implement to certain area, limit to the range of motion of an implement, etc.).

Outputs 110 may include machine commands 115, notifications 122, or a notification presented on on-site system display 132. Machine commands 115 may reflect one or more travel restrictions. Machine commands 115 may include propulsion commands (e.g., a commanded travel speed) or a speed limit (e.g., a travel restriction representing a maximum speed that machine 12 is not permitted to exceed when operating manually, autonomously, or remotely).

Machine commands 115 may be based on other types of travel restrictions. Travel restrictions may include geographic restrictions. For example, the travel permission module of vision system health module 34 may prohibit machine 12 from traveling to one or more locations of a worksite based on the health of vision system 18. These restrictions may be imposed at startup, upon determining that sensors 20, 22, 24 missed a target 32, or when sensors 20, 22, 24 only identified a target 32 when within a predetermined distance. Examples of areas where travel restrictions may be imposed include areas where the travel path or roadway is narrowed, areas in which work is being performed, high-traffic areas, areas in which terrain is rough, areas in which personnel are present, areas in which other machines are present, etc.

Remote supervision system 120 may include a display configured to display notifications 122 based on outputs 110 from controller 30. Remote supervision system 120 may include one or more computer systems configured to monitor the performance of work at a worksite, health of vision systems of a plurality of machines 12, etc. In some aspects, system 120 may enable an operator to remotely control one or more machines 12. Notifications 122 displayed via remote supervision system 120 may identify a particular machine 12 and indicate the health of the vision system 18 that is associated with this machine 12 and/or the health of one or more sensors 20, 22, 24.

On-machine control system 130 may include a display for machine 12 (e.g., a display within a cabin of machine 12, a display of a mobile device used by an operator of machine 12 such as a computer, laptop cellular phone, tablet, system for remote control of machine 12, etc.). On-machine control system 130 may generate a notification (not shown) that indicates the health of vision system 18 overall and/or the health of one or more sensors 20, 22, 24. This notification may indicate that health is great, acceptable, or poor, may identify when a target 32 is identified or missed, may illustrate regions from which machine 12 is prohibited from traveling, or identify a speed regime under which machine 12 is operating based on the health of vision system 18, or identify any other travel permissions.

On-machine control system 130 may assist with machine functions such as the identification, creation, modification, and removal of one or more exclusion zones via a work site interface 136. For example, on-machine control system may present graphical versions of exclusion zones 308 that may be modified by a user. In addition, on-machine control system 130 may present worksite information (e.g., tasks to be performed, a map, topographical information, etc.) and machine information (e.g., location of machine 12, status of fuel, electrical energy, temperature, etc.). While certain elements are described above with respect to remote supervision system 120 and on-machine control system 130, as understood, notifications 122 may be presented via on-machine control system 130, while on-site system display 132 and/or work site interface 136 may be presented with remote supervision system 120.

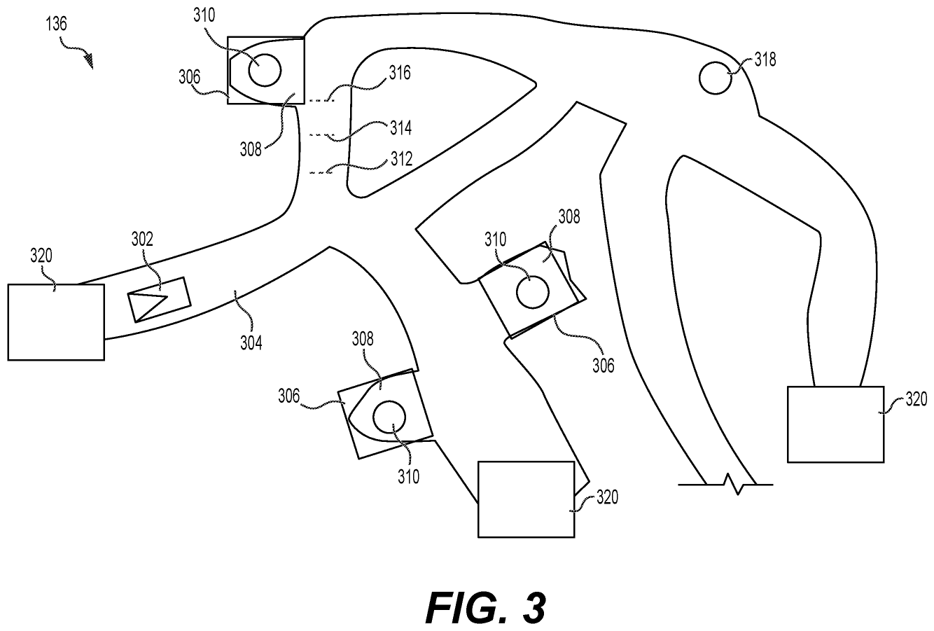

FIG. 3 is a diagram including a representation of a worksite, including elements that may be presented via display 132 of on-machine control system 130. While FIG. 3 is described with reference to graphical elements that are presented via a work site display 136, as understood, features of FIG. 3 may also represent physical structures (e.g., work areas 320, obstacles 318).

Work site display 136 may include a machine element 302 representing a current or previous location of machine 12, one or more work areas 320 of a work site, path elements 304 connecting work areas 320, and target positions 310 within or adjacent to a desired path defined by path elements 304. If desired, the locations of one or more obstacles 318 may be displayed, if known.

Machine element 302 may be displayed and updated periodically or in real time to depict a location of machine 12 relative to path element 304. Path element 304 may represent a compacted or paved surface or another type of intended route for machine 12. This route may typically be free of obstacles, with traffic barrels or other objects being located outside of the route. Machine 12 may be prohibited from contacting sides of path element 304, causing machine 12 to be limited to travel within the route. Further, vision system 18 may be operable to identify objects within the boundaries of path element 304 and ignore objects (e.g., obstructions or barrels) outside of the routes defined with path elements 304. This may improve resolution, processing time, and other aspects of vision system 18.

As indicated above, an exclusion zone 308 may be an area in which controller 30 of machine 12 “excludes” objects, such as targets 32, from impacting travel of machine 12, permitting machine 12 to continue traveling even when objects, including potential obstructions, are identified within zone 308. Each exclusion zone 308 may be defined by exclusion zone boundaries 306, which are shown as four straight lines that define a box in FIG. 3. Other shapes, including more complex and/or irregular shapes may be used as exclusion zone boundaries 306. The size and/or location of each exclusion zone 308 may be set via work site interface 136.

One or more targets 32 may be located at target positions 310 within respective exclusion zone 308. The location of each target position 310 and/or a number of target positions that are present along a particular route may be known to controller 30 (e.g., via exclusion zone feedback 134 as shown in FIG. 2 which may be an input that sets a size or location of an exclusion zone 308, or a location of a target 32). This may enable controller 30 to determine when a target is missed.

Positions 312, 314, and 316 represent different positions at which machine 12 may be present when a target 32 is identified, this example of target 32 being within target position 310 to the left of position 316. Position 312 may represent a relatively distant or remote position, position 314 may represent an intermediate position, and position 316 may represent a near position.

Remote position 312 may correspond to a maximum distance at which vision system 18 is capable of identifying a target 32 when vision system 18 is at full health. Intermediate position 314 may represent a location at which vision system 18 is capable of identifying the same target 32 when vision system 18 operates in a satisfactory manner. Near position 316 may represent a minimum acceptable distance from a target 32 at which vision system 18 identifies the target 32 in target position 310.

The distances associated with position 312, 314, 316 may be set in advance. In other configurations, one or more of these distances may be created or modified based on an interaction from a user (e.g., by changing a numerical distance or by relocating one or more positions 312, 314, 316 via work site interface 136 shown in FIG. 2).

### INDUSTRIAL APPLICABILITY

System 10 may be useful in any machine in which one or more sensors are used to enable semi-autonomous, fully autonomous, and/or remote operation of a machine 12. If desired, system 10 may be used in a manually operated machine e.g., as a feature for assisting an operator. System 10 may operate continuously, monitoring travel permissions continuously or periodically. System 10 may determine when targets are missed and update travel permissions accordingly. For example, system 10 may relax or impose restrictions based on the current health of vision system 18, allowing system 10 to adjust to disturbances that impact the operation of sensors 20, 22, 24 such as sensor failures, disconnected sensors, or loss of alignment.

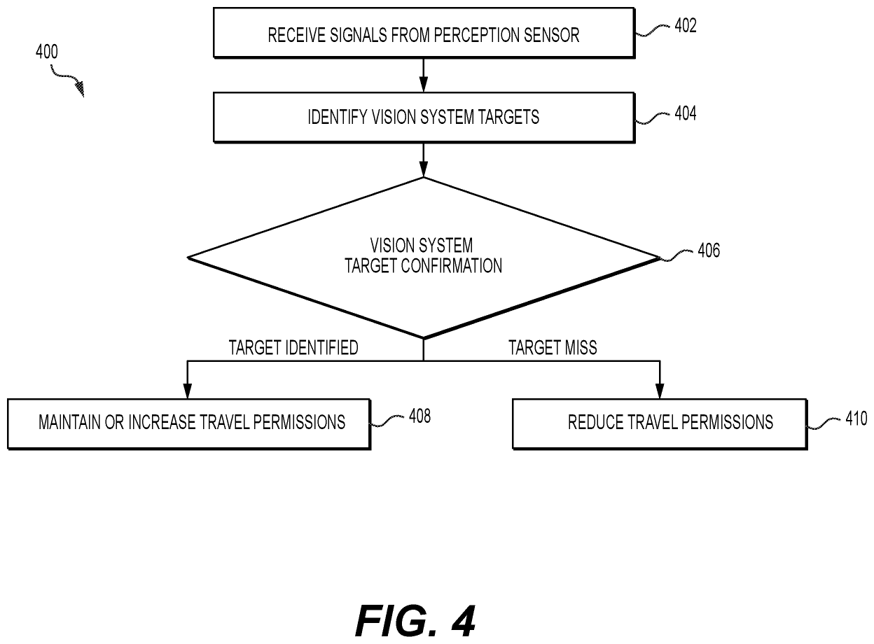

With reference to a haul truck machine 12 for use at a surface mine or other worksite as shown in FIG. 1, during operation of system, machine 12 may perform tasks for receiving and hauling material. Vision system 18 may monitor the health of vision system 18 continuously during the operation of machine, intermittently (e.g., in response to a request received from an operator or from a supervisor), and/or during startup of machine 12. An example process of monitoring the health of vision system 18 and controlling one or more aspects of machine 12 based on this health is described below with respect to FIG. 4.

FIG. 4 is a flowchart illustrating an exemplary method 400 for setting travel permissions of machine 12. While steps 402-410 of method 400 are shown and described in a particular order, as understood, one or more of steps 402-410 may be performed in a different order and/or in a partially or entirely overlapping manner. As described below, at least some steps of method 400 are performed after calibration of vision system 18 and while machine 12 is in motion.

A step 402 may include receiving signals from one or more perception sensors. This may include receiving, with vision system health module 34 of controller 30, vision signals from sensors 20, 22, 24. If desired, vision system health module 34 may receive a location of machine 12 that is generated with location sensor 26, or distance information from sensors 20, 22, 24. In some aspects, the signals from perception sensors 20, 22, 24 include data that represents the location of a target 32. This data may be in the form of a point cloud, the target being represented by a plurality of points in the point cloud. The point cloud, or other data, may also indicate a distance of the target from the sensor that is directed toward the target, allowing a single sensor 20, 22, 24 to provide a signal that identifies the presence of an object and that indicates a distance of multiple points of the object from machine 12.

In a step 404, vision system health module 34 of controller 30 may identify one or more vision system targets 32. This determination may be made based on the signals received in step 402. As an example, vision system health module 34 may identify targets 32 as machine 12 traverses a worksite. Also in step 404, targets 32 may be identified based on known features of target 32. These features may include a height, a width, outline, or other aspect of target 32.

Each identified target 32 may be logged by vision system health module 34, along with characteristics of machine 12 at the time of identification. These characteristics may also include the location of machine 12 at the time target 32 is identified (e.g., as indicated by signals from location sensor 26), the location of sensors 20, 22, 24 on machine 12 (e.g., whether each sensor 20, 22, 24 is on the top, front, sides, or rear of machine 12), weather conditions at the time target 32 is identified, the presence of dust at the time target 32 is identified, and other suitable information.

At step 406, vision system health module 34 may confirm whether one or more targets 32 were identified successfully. This confirmation may be made by vision system health module 34 by correlating targets 32 identified in step 406 with targets 32 at known target positions 310. Each time machine passes a known target position 310, vision system health module 34 may determine whether one or more of sensors 20, 22, 24 identified target(s) 32 present within this target position 310. The distance between machine 12 and target 32 at the time of identification may also be evaluated by vision system health module 34 in step 406. When multiple targets 32 are present in a single position 310, successful identification may require that all targets 32 are identified. Further, successful identification may require that a target 32 be identified with a minimum resolution (e.g., by evaluating whether a minimum number of points in a point cloud correspond to a target 32).

When a target 32 or predetermined number of targets 32 (e.g., two, three, or more) are successfully identified, the determination in step 406 results in performance of a step 408. This successful identification occurs, for example, when a target 32 within target position 310 is identified with machine 12, and if desired, taking distance between machine 12 and target 32 into account. For example, as shown in FIG. 3, identification of a target within zone 308 while machine 12 is present at position 312, or farther, may be considered a successful identification.

In examples where vision system 18 does not identify a target 32, method 400 may proceed to step 410. Vision system health module 34 may determine that a target 32 was missed when machine 12 passes a target 32 within a target position 310 of an exclusion zone 308 without sensors 20, 22, 24 outputting signals that facilitate identification of the target. A missed target 32 may also be determined when machine 12 only identifies a target 32 while within a predefined close distance (e.g., the distance associated with position 316). However, false target misses may be avoided by disregarding targets 32 that are missed by multiple machines 12, which may indicate that a target 32 is obscured, relocated, or knocked over.

Intermediate position 314, when employed, may be associated with either a successful identification or an unsuccessful identification. Successful identifications while machine 12 is at position 314 may be correlated with sub-optimal conditions, such as presence of rain, fog, dust, etc., or other conditions in which vision system 18, while healthy, may tend to identify targets 32 more slowly (e.g., when machine 12 is closer to target 32 than position 312). If desired, position 314 may be correlated with a missed target 32 when conditions for identifying target 32 are optimal (e.g., there is no rain, fog, dust, etc.) and system 18 is expected to detect target 32 earlier (e.g., at position 312).

Step 408 may include increasing travel permissions or maintaining travel permissions. In the example of a travel speed limit, machine 12 may have a low or first travel speed limit that is set when machine 12 begins operation. Once a predetermined number of targets are confirmed as being successfully identified by vision system health module 34 during step 408, this first travel speed limit may be increased to a moderate or second travel speed limit. Additional increases to third, fourth, and/or higher speed limits may be performed as predetermined numbers of additional targets are successfully identified.

In the example of geographic restrictions, step 408 may include permitting machine 12 to enter areas, such as one or more work areas 320, only after identification of one or more targets 32. For example, a machine 12 present at machine element 302 shown in FIG. 3 may be prohibited from entering a location, such as work area 320 shown at the bottom center of FIG. 3, unless step 406 results in confirmation that two targets 32 were identified, one in each exclusion zone 308. A machine traveling from machine element 302 to the work area 320 at the lower-right portion of FIG. 3 may be directed to take a path that passes the exclusion zone 308 at the upper portion of FIG. 3. This may ensure that the health of vision system 18 is high, obstacles 318 are properly identified, and machine 12 takes appropriate action (e.g., changing direction, slowing down, or stopping) upon identifying an obstacle 318.

Step 410 may include reducing travel permissions based on a missed target 32. In the example of a travel speed limit, machine 12 may have the travel speed limit reduced from, for example, a third speed that is higher than the second speed and higher than the first speed. The speed limit may be reduced to either the first speed or to the second speed. In some examples, a complete miss of a target 32 may cause vision system health module 34 to more significantly reduce travel permissions (e.g., reduce the travel speed limit from the third speed limit to the first speed limit), while identification of a target 32 from position 314 or position 316 may result in a less severe restriction (e.g., reduce the travel speed limit from the third speed limit to the second speed limit).

Similarly, step 410 may include prohibiting machine 12 from traveling to a particular location, such as one or more work areas 320, in addition to or instead of the reduction in travel speed limit. Other actions may be taken by vision system health module 34, such as prohibiting machine 12 from performing certain tasks, operating implements, etc.

In some aspects, the results of steps 406, 408, and/or 410 may be displayed to an operator, supervisor, fleet manager, etc., via notifications 122 or on-site system display 132 (FIG. 2). Examples of notifications 122 may include an indication of current travel permissions, an indication that a target 32 was identified, and an indication that a target 32 was missed. Notifications 122 may identify a health of system 18 (e.g., fully health, moderately healthy, or poor) and/or may identify which sensor(s) have missed a target and therefore may need maintenance of repair.

The disclosed system and method may facilitate use of trucks or other machines capable of autonomous and/or remote operation. For example, the system and method may ensure reliable operation of machines with vision systems that are used for detecting paths, obstacles, and other objects. When used as an operator-assist feature or for autonomous or remote machines, the use of vision system health for setting travel permissions may improve safety as well as productivity. The system and method may further reduce downtime by identifying when sensors become degraded, and also allow continued, safe operation until sensors can be cleaned, repaired, or replaced. The health of the sensor system may be continuously monitored in a system that performs checks during motion, avoiding disruption of a work cycle. Additionally, the system and method involve the use of targets that can be deployed where desired on a worksite the locations of these targets being set with an interface, without the need for a dedicated test area containing specially-designed calibration targets.

It will be apparent to those skilled in the art that various modifications and variations can be made to the disclosed system and method without departing from the scope of the disclosure. Other embodiments of the system and method will be apparent to those skilled in the art from consideration of the specification and system and method disclosed herein. It is intended that the specification and examples be considered as exemplary only, with a true scope of the disclosure being indicated by the following claims and their equivalents.

What is claimed is:

1. A system for speed control of a machine, the system comprising:
a mobile machine configured for traversing a worksite, the mobile machine including ground-engaging devices for propelling the mobile machine at a travel speed; and
a vision system including:
a perception sensor; and
a controller configured to:
receive signals from the perception sensor,
determine when the perception sensor successfully identifies a target,
determine when the perception sensor is unsuccessful in identifying the target, and
set a travel speed limit of the machine based on whether the target was successfully identified.

2. The system of claim 1, wherein the controller is configured to increase the travel speed limit upon determining that the perception sensor successfully identified the target.

3. The system of claim 1, wherein the controller is configured to reduce the travel speed limit upon determining that the perception sensor was unsuccessful in identifying the target.

4. The system of claim 1, wherein the controller is further configured to increase the travel speed limit based on determining that the perception sensor identified the target from a predetermined distance, or farther, from the target.

5. The system of claim 1, wherein the controller is configured to:
set the travel speed limit of the machine to an initial speed, and
increase the travel speed limit from the initial speed to an increased speed upon determining that the perception sensor successfully identified the target.

6. The system of claim 1, wherein the controller is configured to store a location of the target and determine that the perception sensor was unsuccessful in identifying the target based on the signals and a known location of the target.

7. The system of claim 1, wherein the controller is configured to identify targets located in an exclusion zone, the exclusion zone being an area in which the machine continues traveling when an object is identified.

8. The system of claim 7, wherein the controller is configured to reduce the travel speed of the machine or cause the machine to stop when an obstacle is identified outside of the exclusion zone.

9. The system of claim 7, wherein the controller is configured to receive an input that modifies a size or a location of the exclusion zone.

10. The system of claim 1, wherein the machine is a haul truck, a liquid storage truck, an earthmoving machine, or a paving machine.

11. A system for setting travel permissions of a machine, the system comprising:
a perception sensor configured to generate a signal that indicates a presence of an object and a distance of the object; and
a controller configured to:
receive the signal,
determine when the signal indicates the presence of a target,
confirm whether a target was successfully identified based on the signal,
maintain, increase, or reduce a travel permission based on the confirmation.

12. The system of claim 11, wherein the travel permission includes at least one of a travel speed limit for the machine, a minimum distance of the machine from an object, a destination of the machine, or operation of an implement of the machine.

13. The system of claim 11, further including a global navigation satellite system configured to determine a location of the machine.

14. The system of claim 11, wherein the controller is configured to store a location of the target and confirm that the target was not successfully identified based on the signal and the stored location of the target.

15. The system of claim 11, wherein the sensor is configured to identify the target while the machine is in motion.

16. The system of claim 11, wherein the travel permission is increased from an initial travel permission in response to the controller determining that the signal indicated the presence of a predetermined number of targets.

17. A method for controlling travel permissions for a machine, the method comprising:
receiving signals from a perception sensor;
identifying one or more vision system targets while the machine is in motion;
confirming whether each vision system target is successfully identified; and
setting a travel permission of the machine based on whether the target was successfully identified.

18. The method of claim 17, further including determining that the perception sensor missed the one or more targets subsequent to a calibration of the perception sensor.

19. The method of claim 17, further including receiving distance signals from the perception sensor or from another sensor and using the distance signals to determine that the one or more vision system targets was not successfully identified.

20. The method of claim 17, wherein the travel permission is a travel speed limit of machine.
